(19) United States
(12) Patent Application Publication
(10) Pub. No.: US 2022/0225644 A1
(43) Pub. Date: Jul. 21, 2022

(54) A METHOD FOR REDUCING AN AMOUNT OF MICROORGANISMS IN BREWERS SPENT GRAINS

(71) Applicant: Tetra Laval Holdings & Finance S.A., Pully (CH)

(72) Inventors: Erik Börjesson, Lund (SE); Bodo Rewolle, Malmö (SE); Ola Ström, Bjärred (SE); Mirko Stanic, Zürich (CH)

(21) Appl. No.: 17/596,621

(22) PCT Filed: Jun. 9, 2020
(86) PCT No.: PCT/EP2020/065969

§ 371 Date: Dec. 14, 2021

(30) Foreign Application Priority Data
Jun. 14, 2019 (EP) 19180204.0

(51) Int. Cl. A23L 3/22; A23L 7/20; C12F 3/06; B01F 23/53; B01F 27/80; B01F 25/50; B01F 35/21; B01F 35/22; B01F 35/221

(52) U.S. Cl. CPC A23L 3/22; A23L 7/20; C12F 3/06; B01F 23/53; B01F 27/92; B01F 25/50; B01F 35/2117; B01F 35/2203; B01F 35/2211; B01F 27/80

(57) ABSTRACT

The present invention relates to a method (300) for reducing an amount of microorganisms in brewers spent grains (BSG). The method (300) comprises feeding (S305) a liquid (120) and the BSG (110) into a mixing arrangement (130), mixing (S310), by means of the mixing arrangement (130), the liquid (120) and the BSG to form a mixture, feeding (S330) the mixture into a heat exchanger (140), and heating (S335), by means of the heat exchanger (140), the mixture for a predetermined period of time at a predetermined temperature such that the amount of microorganisms in the BSG (110) is reduced.

### TECHNICAL FIELD

The invention relates to a method for reducing an amount of microorganisms in brewers spent grains.

### BACKGROUND ART

Brewers spent grains (BSG) is a by-product from the brewing industry. The BSG comprises starch sources such as barley grains used to brew beer. A produced amount of the BSG for each 100 liter beer may be about 15 Kg. The BSG contains proteins, fibers, and carbohydrates. Although the BSG is a nutritious source, it is microbiologically unstable as it is typically contaminated with pathogenic microorganisms such as Bacillus cereus and Enterobacteriaceae. Therefore, the BSG rapidly degrades and spoils within about 24 hours which makes it difficult to trade or use at all. Today, breweries pay a fee to waste treatment for each kilogram of the BSG that they produce and the BSG is mainly used as animal feed or in biogas installations.

Therefore there is a need to preserve nutrients of the BSG and to make it a nutrition, instead of a costly undesired waste product. In particular, there is a need to make the BSG a human nutrition.

### SUMMARY

It is an object of the invention to at least partly overcome one or more of the above-identified limitations of the prior art. In particular, it is an object to provide a method to reduce an amount of microorganisms in the BSG.

According to an aspect of the present inventive concept there is provided a method for reducing an amount of microorganisms in the BSG. The method comprises feeding a liquid and the BSG into a mixing arrangement, mixing, by means of the mixing arrangement, the liquid and the BSG to form a mixture, feeding the mixture into a heat exchanger, and heating, by means of the heat exchanger, the mixture for a predetermined period of time at a predetermined temperature such that the amount of microorganisms in the BSG is reduced.

The method is advantageous in that it allows reducing the amount of microorganisms such as Bacillus cereus and Enterobacteriaceae in the BSG and thereby allows it to be used as human nutrition i.e. an ingredient in the food industry. The method in turn allows to reduce waste products of the beer brewing by making the BSG into a human nutrition instead of the costly waste product. Thereby the method is economically and environmentally advantageous.

The BSG is a rather dry product which is not suitable for feeding into the heat exchanger. The mixing, by means of the mixing arrangement, of the BSG and the liquid allows to disperse the BSG to be able to feed that into the heat exchanger. The mixing, by means of the mixing arrangement, of the BSG and the liquid further allows to form an even mixture i.e. a homogeneous mixture. The method is also advantageous in that it allows a continuous process and does not require any chemical agent. The heating of the mixture may be performed using conventional Ultra High Temperature (UHT) processing techniques, including allowing a heat recovery. The heating of the mixture may be performed using an indirect heating process such that the BSG is not directly exposed to the heating media. For instance, the heating of the mixture may be performed using a tubular heat exchanger. The tubular heat exchanger may provide optimal performance, long production time and low maintenance costs.

By reducing the amount of microorganisms in the BSG is hereby meant removing, killing or deactivating at least 90%, or at least 99%, of living microorganisms in the BSG.

By the mixing arrangement is hereby meant any unit that is capable of dispersing BSG in water.

The predetermined temperature may be in a range of 127 to 140° C. The predetermined temperature may preferably be in a range of 133 to 138° C. The optimal predetermined temperature may be 137° C.

The predetermined period of time may be in a range of 30 to 90 seconds. The predetermined period of time may preferably be in a range of 40 to 80 seconds. The predetermined period of time may more preferably be in a range of 55 to 65 seconds. The optimal predetermined period of time may be 60 seconds.

The above predetermined time and temperature ranges may provide sufficient heating to reduce the amount of microorganisms in the BSG. The predetermined temperature may scale inversely with the predetermined time such the heating at a higher temperature may require a shorter time.

A solid content of the BSG may be in a range of 20% to 40% by weight of the BSG. The solid content of the BSG may preferably be in a range of 20% to 30% by weight of the BSG. The solid content of the BSG may more preferably be in a range of 20% to 25% by weight of the BSG. The range may depend on the starch source used for brewing beer and may therefore depend on the starch source material.

The feeding may comprise feeding the liquid and the BSG such that a solid content of the mixture may be in a range of 10% to 20% by weight of the mixture. The solid content of the mixture may preferably be in a range of 11% to 17% by weight of the mixture. The optimal solid content of the mixture may be 17% by weight of the mixture. This range may provide a sufficient fluidity and concentration to feed the mixture into the heat exchanger. Thereby this range may result into processing a highest amount of the solid BSG which may be reduced according to the above mentioned method.

The mixing of the liquid and the BSG may comprise agitating, by means of an agitator, the liquid and the BSG. Thereby the agitating, by means of the agitator, may improve the homogeneity of the mixture. This may in turn facilitate the feeding of the mixture into the heat exchanger and heating of the mixture to reduce the amount of the microorganisms therein.

The mixing of the liquid and the BSG may comprise circulating, by means of a circulating loop, the mixture out of and into the mixing arrangement, such that the formation of the mixture is facilitated. The circulating of the mixture out of the mixing arrangement may be performed from a bottom portion of the mixing arrangement into a top portion of the mixing arrangement. This may in turn reduce a risk of sedimentation. The circulating, by means of the circulation loop, may further improve the homogeneity of the mixture. The circulating may be performed initially to speed up the formation of the homogeneous mixture and to facilitate stabilizing of the mixture.

The circulating may comprise pumping, by means of a screw pump, the mixture. An advantage brought by the screw pump is that the screw pump may facilitate the pumping of the mixture. The screw pump may pump the mixture out of the mixing arrangement via a slit arranged at the bottom of the mixing arrangement. The pumped mixture may be circulated into the mixing arrangement via the circulation loop to facilitate the formation of the homogeneous mixture.

The method may further comprise introducing a viscosity increasing agent into the liquid and the BSG, such that a viscosity of the mixture is increased. Increased viscosity facilitates more even dispersion of the BSG in the liquid as well as reduces the risk of BSG sedimentation.

The liquid may be water. The liquid may be water only. The liquid may comprise at least 99% water.

The feeding of the mixture into the heat exchanger may comprise pumping the mixture by means of a screw pump. The same screw pump that may be used for pumping the mixture out of the mixing arrangement into the circulation loop may be used to feed the mixture into the heat exchanger. The pumping of the mixture into the heat exchanger may be performed subsequent to the circulating of the mixture.

The feeding of the BSG and the liquid into the mixing arrangement may further comprise determining a weight of the BSG being fed into the mixing arrangement and feeding an amount of the liquid based on the determined weight of the BSG. Thereby, the weight of the BSG being fed into the mixing arrangement may be determined, as the BSG weight may depend e.g. types of grains used in the brewing industry. The determining of the weight of the BSG may hence facilitate adjusting the solid content of the mixture i.e. the BSG to the liquid ratio.

The method may further comprise, subsequent to the heating of the mixture, drying the mixture to form a dried BSG product and grinding the dried BSG product to form a flour. Thereby, the flour may be used as human nutrition i.e. an ingredient in the food industry. The drying of the mixture may be performed using any conventional drying techniques including e.g. belt pressing and evaporation. The grinding of the BSG product may be performed using any conventional grinding techniques.

By drying is hereby meant removal or separation of the major part of liquid in the mixture, allowing the BSG to be grinded to flour. The dried BSG and thus also grinded BSG still have a minor liquid content.

The BSG is originated from seeds or grains chosen from a group consisting of barley, wheat, rye, corn, rice, oats and combinations thereof. The BSG may comprise any other grains used in the brewing industry. In case of forming the flour, by drying and grinding of the dried BSG product, the formed flour may have various nutrients depending on the grains used in the brewing industry and may hence provide various flours i.e. various ingredients to the food industry.

The BSG may comprise particles having a dimension in a range from 100-4000 μm. The dimension of the particles may vary depending on the grains used in the brewing industry.

According to another aspect of the present inventive concept there is provided a method for brewing beer. The method comprises malting raw grains, mashing the malted grains such that wort and BSG are formed, lautering the wort and the BSG such that the wort and the BSG are separated, processing the wort to produce beer, and reducing an amount of microorganisms in the BSG by using the method according to the first aspect.

The raw grains may comprise seeds chosen from a group consisting of barley, wheat, rye, corn, rice, and oats and combinations thereof. The malting, mashing, lautering and processing of the wort may be performed in manners which per se are known in the beer brewing industry.

The method, according to the second aspect, allows producing the beer and reducing the amount of the microorganisms in the BSG in the same method. The above mentioned features of the first method according to the first aspect, when applicable, apply to this second aspect as well. In order to avoid undue repetition, reference is made to the above.

Still other objectives, features, aspects and advantages of the invention will appear from the following detailed description as well as from the drawings.

### BRIEF DESCRIPTION OF THE DRAWINGS

Embodiments of the invention will now be described, by way of example, with reference to the accompanying schematic drawings, in which

FIG. 1 is an schematic illustration of an arrangement capable of reducing an amount of microorganisms in BSG.

FIG. 2 is a block scheme of a method for reducing an amount of microorganisms in BSG.

FIG. 3 is a block scheme of a method for brewing beer.

### DETAILED DESCRIPTION

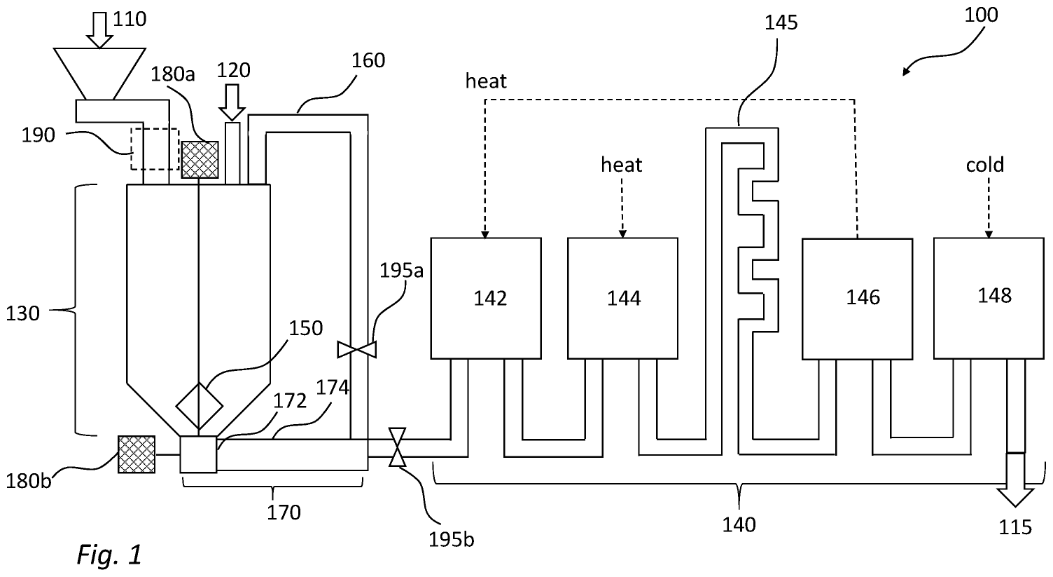

With reference to FIG. 1 an arrangement 100 is illustrated. The arrangement 100 may be used to reduce an amount of microorganisms in BSG 110. The arrangement 100 may be installed next to a brewing facility such that the produced BSG 110 from beer brewing may directly be fed into the arrangement 100.

In the following the BSG 110 and the arrangement 100 in relation to reducing an amount of microorganisms in the BSG 110 will be described.

The BSG 110 may originate from any grains or seeds used in brewing industry. The BSG 110 may originate from barley, wheat, rye, corn, rice, oats and combinations thereof. The BSG 110 may be in a form of ground malt. The BSG 110 may comprise water. The BSG 110 may have a pH of 6.7-6.9. The BSG 110 may be comprise particles a dimension in a range from 100-4000 μm. As an example, the dimension of the BSG particles may be distributed, as follows: below 160 μm (d₁₀), between 950 to 1650 μm (d₅₀), 2900 μm (d₉₀) and 4000 μm (dₘₐₓ). A solid content (SC) of the BSG 110 may be in a range from 20% to 40% by weight of the BSG 110. The BSG 110 may have a water content of 73-82%. Still, the BSG 110 may be rather solid i.e. show no pronounced flowability, no bridging, and no free water. A bulk density of the BSG 110 may be 0.4-0.5 g/ml.

The arrangement 100 may comprise a mixing arrangement 130 and a heat exchanger 140. The general function of the mixing arrangement 130 is mixing and the general function of the heater exchanger 140 is heating.

The mixing arrangement 130 may be a dispersion tank. A volume of the dispersion tank may as an example be 1500 liter. FIG. 1 shows that the mixing arrangement 130 has two inlets. One inlet may be used to feed a liquid 120 and one inlet may be used to feed the BSG 110 into the mixing arrangement 130. The liquid 120 may be water.

The mixing arrangement 130 may have more than two inlets. For instance, mixing arrangement 130 may have a third inlet to feed a viscosity increasing agent into the liquid 120. Alternatively, the viscosity increasing agent may be introduced into the liquid 120. The viscosity increasing agent may increase a viscosity of the mixture.

A weight of the BSG 110 being fed into the mixing arrangement 130 may be determined, by means of a sensor 190. The sensor 190 may be any suitable conventional sensor arranged such that the weight of the BSG 110 may be determined while feeding the BSG 110 into the mixing arrangement 130, i.e. continuous in-line determination. Alternatively, the BSG 110 may be weighted prior to feeding the BSG 110 into the mixing arrangement 130. An amount of the liquid 120, based on the determined weight of the BSG 110, may be fed into the mixing arrangement 130. The feeding of the liquid 120 and the BSG 110 may be performed such that a solid content of the mixture may be in a range of 10% to 20% by weight of the mixture. The mixing arrangement 130 may mix the BSG 110 and the liquid 120 to form an even and a homogeneous mixture.

The mixing arrangement 130 may further comprise an agitator 150. The agitator 150 may include a propeller, a screw or similar. The mixing arrangement 130 may comprise more than one agitator 150. The agitator 150 may agitate the BSG 110 and the liquid 120. FIG. 1 shows that the agitator 150 is arranged at a bottom portion of the mixing arrangement 130. The agitator 150 may be arranged anywhere in the mixing arrangement 130 e.g. at a middle portion. FIG. 1 shows that the agitator 150 is connected to a motor 180a. FIG. 1 shows that the motor 180a, connected to the agitator 150, is arranged above the mixing arrangement 130. The motor 180a may provide mechanical energy to agitate the agitator 150.

The mixing arrangement 130 may further comprise a circulation loop 160, shown in FIG. 1. The mixing arrangement 130 may comprise more than one circulation loop 160. The mixture may be circulated by means of the circulation loop 160. The circulation loop 160 may connect a bottom portion of the mixing arrangement 130 to a top portion of the mixing arrangement 130. The circulation loop 160 may circulate the mixture out of the bottom portion of the mixing arrangement 130 into the top portion of the mixing arrangement 130. The circulation loop 160 may facilitate the formation of the mixture.

The mixing arrangement 130 may further comprise a slit arranged at the bottom portion of the mixing arrangement 130. The slit may have a circular cross section. The slit may be connected to a screw pump 170. The slit may be connected to a feed screw 172 of the screw pump 170. The feed screw 172 may have an opening facing the slit of the mixing arrangement 130. The opening of the feed screw 172 may have the shape and same size as the slit. The mixture may exit the slit and enter feed screw 172 such that no mixture may remain at an interface between the slit and the feed screw 172. The feed screw 172 may be connected to a motor 180b, as shown in FIG. 1. The motor 180b may provide mechanical energy to the feed screw 172 to pump the mixture from the mixing arrangement 130 into the feed screw 172. The screw pump 170 may further comprise a pump screw executer 174. The feed screw 172 and the pump screw executer 174 may be arranged on the same shaft so as to co-rotate. The motor 180b may hence provide mechanical energy to the pump screw executer 174. The mixture may flow from the feed screw 172 into the pump screw executer 174. The pump screw executer 174 may be connected to the circulation loop 160. The circulating of the mixture into the circulation loop 160 may comprise pumping, by means of the screw pump 170, the mixture. The mixture may flow from the feed screw 172 into the pump screw executer 174 and then into the circulation loop 160. The flow of the mixture from the pump screw executer 174 into the circulation loop 160 may be controlled by means of a valve 195a. The valve 195a may be open initially to speed up the formation of the homogeneous mixture. The valve 195a may be closed after the stabilization of the mixture. A volume of the mixture after stabilization may as an example be 700 liters.

FIG. 1 also shows that the pump screw executer 174 of the screw pump 170 is connected to the heat exchanger 140. The feeding of the mixture into the heat exchanger 140 may comprise pumping, by means of the screw pump 170, the mixture into the heat exchanger 140. The flow of the mixture from the pump screw executer 174 into the heat exchanger 140 may be controlled by means of another valve 195b. The valve 195b of the heat exchanger 140 may be closed initially i.e. when the valve 195a of the circulation loop 160 is open. The valve 195b of the heat exchanger 140 may be open after the mixture has stabilized. The valve 195b of the heat exchanger 140 may be open when the valve 195a of the circulation loop 160 is closed.

Still with reference to FIG. 1, in the following the heater exchanger 140 and the flow of the mixture in the heat exchanger 140 will be described. FIG. 1 shows schematic illustration of a tube type heat exchanger 140. The heating of the mixture may be performed using plate type heat exchanger or any other type of suitable heat exchanger.

The heat exchanger 140 may comprise several parts or portions serving different purposes or the same purposes. The heat exchanger 140 may comprise a preheater 142. The heat exchanger 140 may comprise one or more final heaters 144. FIG. 1 shows only one final heater 144. However, two or more number of final heaters 144 may be connected in series with the final heater 144. The two or more number of the final heaters 144 may be arranged such that they may be connected to or disconnected from the mixture being feed into the heat exchanger 140. The two or more number of the final heaters 144 may increase an area of the heat exchanger 140 and consequently increase an amount of heat transfer.

The heat exchanger 140 may comprise a holding tube 145. The holding tube 145 may comprise corrugated or winding tubes. The holding tube 145 serves the purpose of maintain the mixture being feed into the heat exchanger 140 at a certain temperature for a certain time. The heat exchanger 140 may further comprise a regeneration cooler 146 and a final cooler 148. FIG. 1 shows one regeneration cooler 146 and one final cooler 148. However, there may be more than one regeneration cooler 146 and more than one final cooler 148.

As stated above, after the mixture has been stabilized, the valve 195b of the heat exchanger 140 connected to the pump screw executer 174 may be open. The mixture may hence flow from the pump screw executer 174 into the preheater 142. The BSG 110 and the liquid 120 may continuously and proportionally be fed into mixing arrangement 130 to keep a continuous supply of the mixture. In other words, the BSG 110 and the liquid 120 may continuously be fed into the mixing arrangement 130 while the mixture is passing through the heater exchanger 140 i.e. being heated in the heater exchanger 140, as this is a continuous process. The preheater 142 may preheat the mixture for to a temperature of 70° C. After the mixture has been preheated, by means of the preheater, the mixture may be sent to the final heater(s) 144. The mixture may be heated at a predetermined temperature at the final heater 144. The final heater 144 may be indirectly heated by a steam flow. FIG. 1 shows the steam flow by the dashed-line arrow above the final heater 144. The predetermined temperature may be in a range of 127 to 140° C. The optimal predetermined temperature may be 137° C. After heating of the mixture at the predetermined temperature, the mixture flows into the holding tube 145. The mixture then passes the holding tube 145 which has a length that is chosen such that the passing takes a predetermined period of time. The predetermined period of time may be in a range of 30 to 90 seconds. The optimal predetermined period of time may be 60 seconds. The mixture may then be sent to the regeneration cooler 146. The regeneration cooler 146 may decrease the temperature of the mixture. There may be a heat recovery between the preheater 142 and the regeneration cooler 146. The heat recovery between the preheater 142 and the regeneration cooler 146 is shown by dashed-line in FIG. 1. The mixture may next be sent to the final cooler 148. The final cooler 148 may further decrease the temperature of the mixture. The final cooler may be indirectly cooled by cooling water. FIG. 1 shows the cooling water by the dashed-line arrow above the final cooler 144. The mixture may then be sent out via an outlet 115. The temperature of the mixture leaving the final cooler 148 may be 80° C.

Subsequent to heating of the mixture, by means of the heating exchanger 140, the mixture may be dried. The mixture may be dried to form a dried BSG product. The drying may be done via a drier connected to the outlet 115 such that the heated mixture, the mixture exiting the outlet 115, may be fed into the drier (not shown in FIG. 1). The drier may be any type of conventional drier including e.g. a belt press drier. The drier reduces the amount of water or liquid from the heated mixture to form the dried BSG product. The dried BSG product may be ground to form a flour. The grinding of the dried BSG product may be performed using any conventional grinder or mill (not shown in FIG. 1). The flour may be packed and provided to the food industry. The flour may be used as ingredient in the food industry. Depending on the type of raw grains used in the brewing industry, various flour types may be provided to the food industry.

In the above, the arrangement 100 is described in relation to reducing an amount of microorganism in the BSG 110. However, the arrangement 100 is not limited to reducing an amount of microorganism in the BSG 110 and may be used to reduce an amount of microorganism in other malted kernels as well.

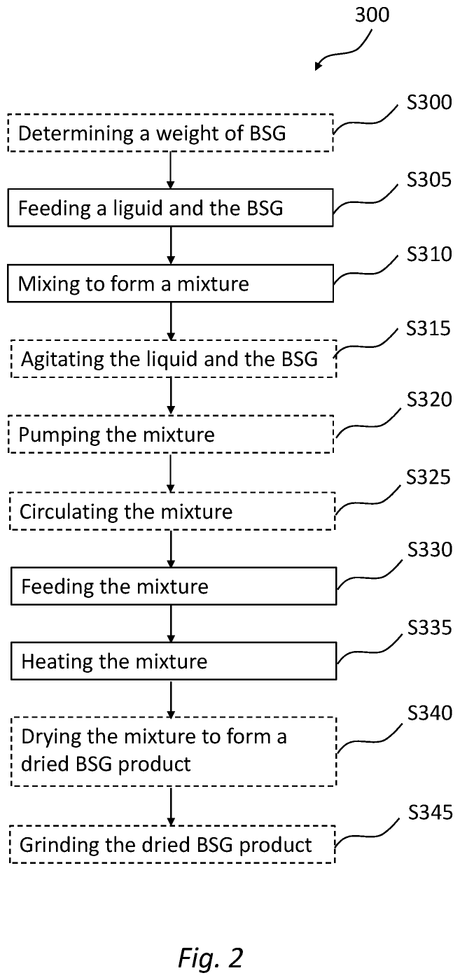

With reference to FIG. 2, a block scheme of a method 300 for reducing an amount of microorganisms in BSG 110 is illustrated. The method comprises the following steps.

The method 300 may comprise determining S300 a weight of the BSG 110 being fed into a mixing arrangement 130. The mixing arrangement 130 may be configured, as described above. The determination of the BSG 110 weight may be performed using a sensor 190, as described above.

The method 300 further comprises feeding S305 a liquid 120 and the BSG 110 into a mixing arrangement 130. The feeding S305 of the liquid 120 may comprise feeding an amount of the liquid 120 based on the determined weight of the BSG 110 being fed into the mixing arrangement 130. The liquid 120 may be as described above.

The method 300 further comprise mixing S310, by means of the mixing arrangement 130, the liquid 120 and the BSG 110 to form a mixture.

The mixing S310 may further comprise agitating S315, by means of an agitator 150, the liquid 120 and the BSG 110. The agitator 150 may be configured, as described above.

The method 300 may further comprise pumping S320, by means of a screw pump 170, the mixture. The screw pump 170 may be configure, as described above.

The mixing S310 may further comprise circulating S325, by means of a circulation loop 160, the mixture out of and into the mixing arrangement 130, such that the formation of the mixture is facilitated. The circulation loop 160 may be configured, as described above. The circulating S325 may comprise pumping S320, by means of the screw pump 170, the mixture.

The method 300 further comprises feeding S330 the mixture into a heat exchanger 140. The heat exchanger 140 may be configured as described above. The feeding S330 of the mixture into the heat exchanger 140 may comprise pumping S320, by means of a screw pump 170, the mixture. The screw pump 170 may be the same screw pump 170, as described above.

The method 300 further comprises heating S335, by means of the heat exchanger 140, the mixture for a predetermined time at a predetermined temperature such that the amount of microorganisms in the BSG 110 is reduced. The predetermined time and the predetermined temperature may be as described above.

The method 300 may further comprise, subsequent to heating S335 of the mixture, drying S340 the mixture to form a dried BSG product. The drying S340 may be performed as described above.

The method 300 may further comprise grinding S345 the dried BSG product to form a flour. The grinding S345 may be performed as described above.

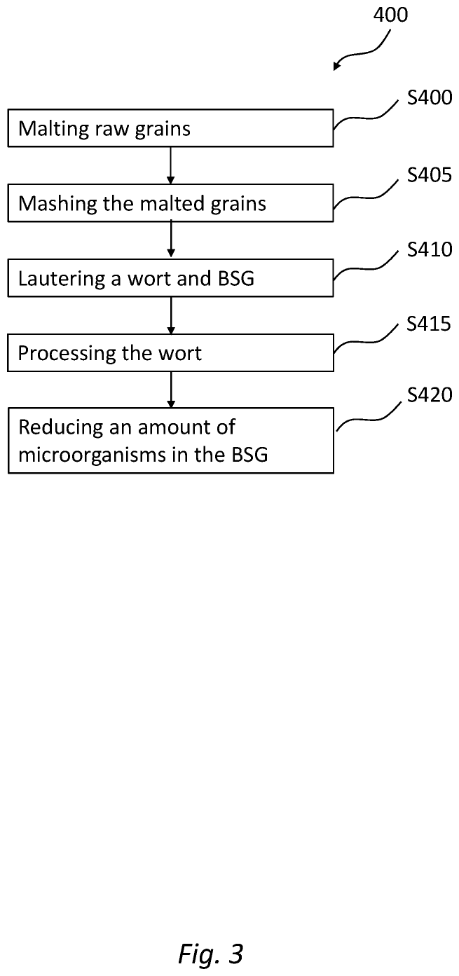

With reference to FIG. 3, a block scheme of a method 400 for brewing beer is illustrated. The method comprises the following steps.

The method 400 comprises malting S400 raw grains 430. The raw grains may originate from any of barley, wheat, rye, corn, rice, oats and combinations thereof. The malting S400 may be performed in a manner which per se is known in the beer brewing industry.

The method 400 further comprises mashing S405 the malted grains 430 such that wort 230 and BSG 110 are formed. The mashing S405 may be performed in a manner which per se is known in the beer brewing industry.

The method 400 further comprises lautering S410 the wort 230 and the BSG 110 such that the wort 230 and the BSG 110 are separated. The lautering S410 may be performed in a manner which per se is known in the beer brewing industry.

The method 400 further comprises processing S415 the wort 230 to produce beer 240. The processing S415 of the wort 230 may be performed in a manner which per se is known in the beer brewing industry.

The method 400 further comprises reducing S420 an amount of microorganisms in the BSG 110 according to the method 300 described in connection with FIG. 2.

From the description above follows that, although various embodiments of the invention have been described and shown, the invention is not restricted thereto, but may also be embodied in other ways within the scope of the subject-matter defined in the following claims.

1. A method for reducing an amount of microorganisms in brewers spent grains, the method comprising:
feeding a liquid and the brewers spent grains into a mixing arrangement, mixing, by means of the mixing arrangement, the liquid and the brewers spent grains to form a mixture,
feeding the mixture into a heat exchanger, and
heating, by means of the heat exchanger), the mixture for a predetermined period of time at a predetermined temperature such that the amount of microorganisms in the brewers spent grains is reduced.

2. The method according to claim 1, wherein the predetermined temperature is in a range of 127 to 140° C.

3. The method according to claim 1, wherein the predetermined period of time is in a range of 30 to 90 seconds.

4. The method according to claim 1, wherein a solid content of the brewers spent grains is in a range of 20% to 40% by weight of the brewers spent grains.

5. The method according to claim 1, wherein the feeding (S305) comprises feeding the liquid and the brewers spent grains such that a solid content of the mixture is in a range of 10% to 20% by weight of the mixture.

6. The method according to claim 1, wherein the mixing of the liquid and the brewers spent grains comprises agitating, by means of an agitator, the liquid and the brewers spent grains.

7. The method according to claim 1, wherein the mixing of the liquid and the brewers spent grains comprises circulating, by means of a circulating loop, the mixture out of and into the mixing arrangement (130), such that the formation of the mixture is facilitated.

8. The method according to claim 7, wherein the circulating comprises pumping, by means of a screw pump, the mixture.

9. The method according to claim 1, further comprising introducing a viscosity increasing agent into the liquid and the brewers spent grains, such that a viscosity of the mixture is increased.

10. The method according to claim 1, wherein the liquid is water.

11. The method according to claim 1, wherein the feeding of the mixture into the heat exchanger comprises pumping the mixture with a screw pump.

12. The method according to claim 1, wherein the feeding of the brewers spent grains and the liquid into the mixing arrangement further comprises determining a weight of the brewers spent grains being fed into the mixing arrangement and feeding an amount of the liquid based on the determined weight of the brewers spent grains.

13. The method according to claim 1, further comprising, subsequent to heating of the mixture, drying the mixture to form a dried brewers spent grains product, and grinding the dried brewers spent grains product to form a flour.

14. The method according to claim 1, wherein the brewers spent grains is originated from seeds chosen from a group consisting of barley, wheat, rye, corn, rice, oats and combinations thereof.

15. The method according to claim 1, wherein the brewers spent grains (110) comprises particles having a dimension in a range from 100-4000 μm.
